(19) United States
(12) Patent Application Publication
(10) Pub. No.: US 2008/0243308 A1
(43) Pub. Date: Oct. 2, 2008

(54) Method and Apparatus for Using an Optical Mouse Scanning Assembly in Mobile Robot Applications

(76) Inventor: Michael Trzecieski, Hong Kong (HK)

Correspondence Address: Michael Trzecieski, Flat 1a Caineway Mansion, 130 Caine Rd, Mid Levels, HK

(21) Appl. No.: 11/692,931

(22) Filed: Mar. 29, 2007

(51) Int. Cl. G06F 19/00; G05B 15/00

(52) U.S. Cl. 700/258; 901/46; 700/245

(57) ABSTRACT

A method and apparatus of using an optical mouse scanning assembly for mobile robot platforms is disclosed. The optical mouse scanning assembly is disposed on a portion of the body of the robot platform that faces a propagation surface. In relation to this propagation surface various parameters, such as propagation velocity, slippage of limbs and relative displacement are determinable for the mobile robot in relation to a propagation surfaces.

This application claims priority from United States Provisional Application entitled “Method and Apparatus for Using an Optical Mouse Scanning Assembly in Mobile Robot Applications,” filed on Apr. 8, 2006.

### FIELD OF THE INVENTION

The field of the invention is in the field of optical mice and more specifically for using the optical mouse scanning assembly for facilitating rate and relative displacement sensing for a mobile robotic platform. Background propagation surface of the Invention

Optical mice have become much cheaper in price over the past years and provide relative displacement and velocity information from a first position to a second position for two axes that are at an angle to each other. Typically these rates are up to 100 mm per second. Additionally, the optical sensor is a matrix of CMOS sensors that are directly accessible for providing of an image. Furthermore, optical mouse camera assemblies are very cheap at the moment and this means these are ideal for use as a rate sensor for mobile robotic platforms.

It is therefore an object of the present invention to use an optical mouse scanning assembly for use in relative displacement and rate sensing for a mobile robot platform.

### SUMMARY OF THE INVENTION

In accordance with the invention there is provided a mobile robot platform comprising: a least a motor for facilitating propagation of the mobile robot platform in relation to a propagation surface; a control circuit comprising a memory circuit; a body comprising a portion of the body disposed at a first distance from the propagation surface; and, an optical sensing device (OSD) disposed on the portion of the body facing the propagation surface, wherein the OSD is for reading of image information from the propagation surface and for generating image data in dependence thereon.

In accordance with the invention there is provided a mobile robot platform comprising: a least a motor for facilitating propagation of the mobile robot platform in relation to a propagation surface; a control circuit comprising a memory circuit; a body comprising a portion of the body disposed at a first distance from the propagation surface; a first wheel and a second wheel coupled to the at least a motor and disposed along an approximately common axes and at opposite sides of the body for rotating relative to the body and for contacting the propagation surface; and, a first optical sensing device (OSD) disposed on a portion of the body facing the propagation surface for providing of relative displacement and rate information in relation to movement of the OSD in relation to the propagation surface, wherein the first OSD is for generating at least one of velocity and relative displacement information for the body of the mobile robot platform.

In accordance with the invention there is provided A method comprising: providing an mobile robot platform comprising at least a motor for facilitating propagation of the mobile robot platform in relation to a propagation surface; providing a optical sensing device disposed on a portion of the mobile robot platform for facing the propagation surface; moving of the portion mobile robot platform along the propagation surface along at least one of a first axis and a second axis; receiving of at least one of relative displacement data and rate of displacement data from the optical sensing device; determining at least one of relative displacement and rate of displacement of the portion mobile robot platform from the received at least one of relative displacement data and rate of displacement data.

### BRIEF DESCRIPTION OF THE DRAWINGS

Exemplary embodiments of the invention will now be described in conjunction with the following drawings, in which:

FIG. 1a illustrates a optical sensing device (OSD) in accordance with a first embodiment of the invention disposed on a mobile robot platform;

FIG. 1b illustrates the OSD mounted to the base of a mobile robot platform in the forms of a robotic platform that balances on two wheel;

FIG. 1c illustrates two OSDs mounted to the base of a mobile robot platform in the forms of a robotic platform that balances on two wheel;

FIG. 2a illustrates a displacement sensing device (DSD) in accordance with a second embodiment of the invention mounted in proximity of a propagation surface of a mobile robot platform in such an orientation that it faces a propagation surface of the mobile robot platform;

FIG. 3a illustrates a slippage sensing device (SSD) in accordance with a third embodiment of the invention;

FIG. 3b illustrates a two legged mobile robot platform, or two limb mobile robot platform, from a front view where two SSDs are used for determining foot slippage as well as optionally determining whether the mobile robot platform propagates along an approximately straight line; and,

FIG. 4 illustrates a method for the mobile robot platform.

### DETAILED DESCRIPTION OF EMBODIMENTS OF THE INVENTION

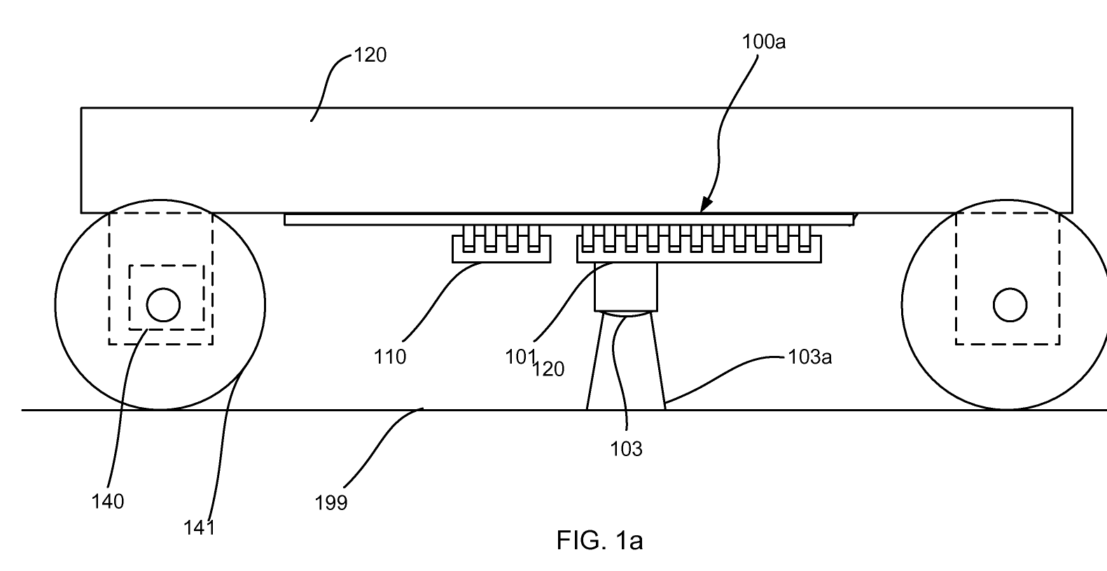

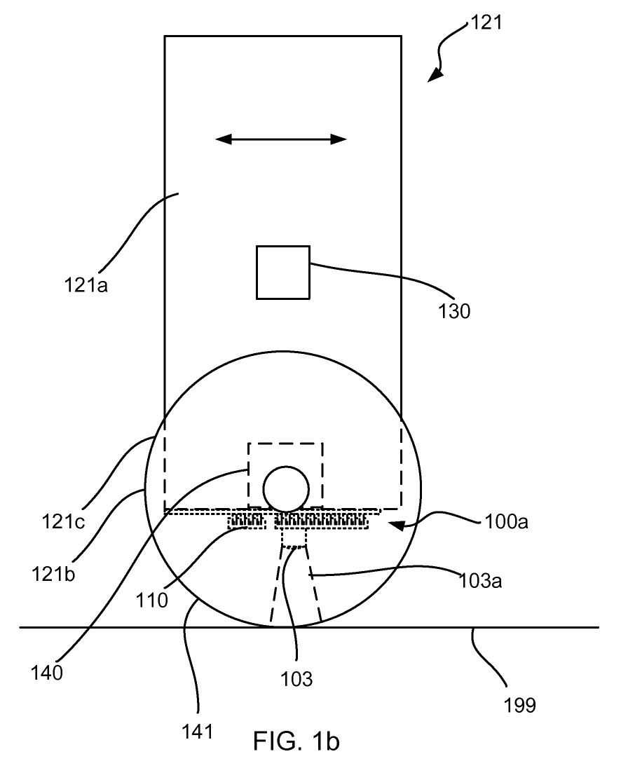

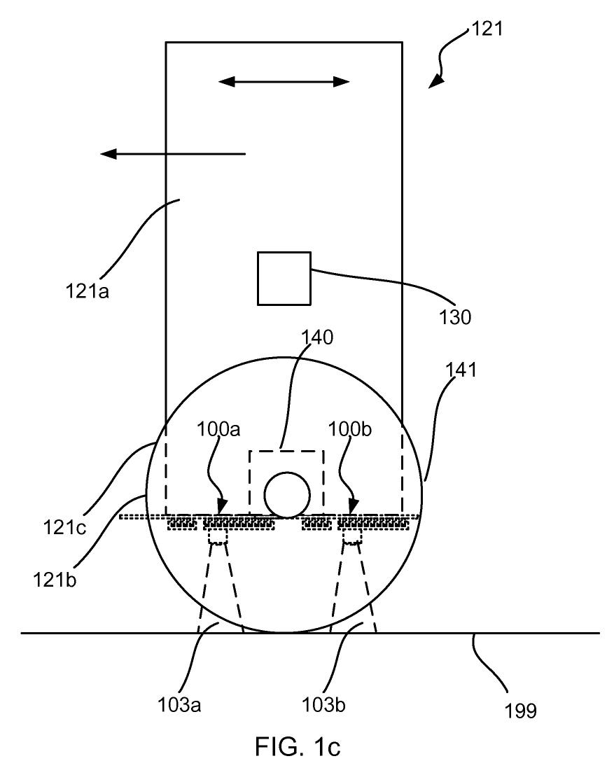

FIG. 1a illustrates an optical sensing device (OSD) 100a in accordance with a first embodiment of the invention disposed on a mobile robot platform 120. The optical sensing device 100a comprises a first optical mouse scanning assembly 101. A processor 110 is coupled therewith for receiving of data therefrom. In use, a first set of data is provided from the first optical mouse scanning assembly 101. A motor 140, which in this case is coupled to at least a wheel 141, is provided for facilitating propagation of the mobile robot platform 120.

From this first set of data, relative movement determination is made for movement of the OSD 100a from a first position to a second position. This data typically includes approximate velocity and approximately relative displacement. Through the use of the lens 103, an image that is further away from the first optical mouse scanning assembly 101 is utilized as if the first optical mouse scanning assembly 101 is operating on a propagation surface 199 that is approximately 5 mm away, as is typically for an optical mouse, from an aperture of the camera formed as part thereof. For the current embodiment, the OSD 100a is typically mounted at a distance of a few centimeters away from the propagation surface 199 on which the mobile robot platform 120 is propagating. The lens 103, for example, brings the propagation surface 199 in the form of a floor or walls of a room into focus of the camera and as such allows for using objects that are a few centimeters away to be used for approximate velocity and approximate relative displacement determination. A field of view of the optical mouse scanning assembly 101 is denoted as 103a.

FIG. 1b illustrates the OSD 100a mounted to the base of a mobile robot platform 121 in the forms of a robotic platform that balances on two wheels, 121b and 121c (hidden behind 121b). A motor 140, which in this case is coupled to at least a wheel 141a, is provided for facilitating propagation of the mobile robot platform 120.

In this case, at least one OSD 100a is disposed in an orientation such that an image formed, or image information, on the camera portion of the optical mouse scanning assembly 101 is that of a propagation surface 199 on which the mobile robot platform 121 is for propagating. A field of view of the optical mouse scanning assembly 101 is denoted as 103a. For a mobile robot platform 121, in the form of a balancing robot platform, to operate in a balance mode of operation, information such as tilt of the body 121a in relation to the propagation surface 199 and also rate of tilt are parameters that facilitate balancing operations.

In other terms, the tilt angle and the rate of change of the tilt angle are preferably determined at intervals for use in executing of a balance control loop. Typically, an accelerometer 130 is used for determining the tilt angle of the body 121a and a rate sensor, in the form of a gyroscope, is used to determine the rate of change of the tilt angle. Unfortunately, rate sensors are known to be expensive.

As such, utilizing an OSD 100a that comprises the optical mouse scanning assembly 101a instead of the gyroscope, facilitates balancing of the robot. Because the OSD 100a is facing the propagation surface 199, as the body 121a of the robot platform tilts for both positive and negative angles in relation to propagation surface, the image data that is generated by the OSD 100a, from the image information, changes and as such determination is made as to the rate of change and from this information a balance control loop that is executing within the processor 110 uses this information to balance of the robot platform 121 on two wheels in a stationary mode of operation. For a stationary balancing robot, use of a single OSD 100a is preferable, however, for a balancing mobile platform that propagates in a direction, preferably two OSDs are utilized, as is shown in FIG. 1c for use in rate of tilt determination, where signals received from the first OSD 100a. Fields of views of the first and second OSDs, 100a and 100b, are denoted as 103a and 103b, respectively. A motor 140, which in this case is coupled to at least a wheel 141, is provided for facilitating propagation of the mobile robot platform 121.

In this case both OSDs (100a and 100b) are disposed to face the propagation surface 199 and the first OSD 100a is used to determine the forward or backward velocity of the mobile robot platform and the second OSD 100b is used for determining the rate of tilt of the body of the robot as it leans forward or backward when the balance control loop is in execution. In this manner, both the OSDs, 100a and 100b, are used on conjunction and the rates are added and subtracted in order to determine the rate of change of the lean of the upper body with respect to propagation surface 199. Optionally with a single OSD 100a, an optical ranging device is disposed along with the OSD 100a for determining a distance to the propagation surface 199 from the body 121a.

Advantageously, because the OSD 100a uses the optical mouse scanning assembly, the date information derived therefrom is approximately color and object independent, thus facilitating use of the balancing robot platform on various multi colored and multi textured propagation surface independent. Further advantageously, by using two of these OSDs (100a and 100b), additionally color immunity is offered as well as improved rate sensing for propagating robot platforms.

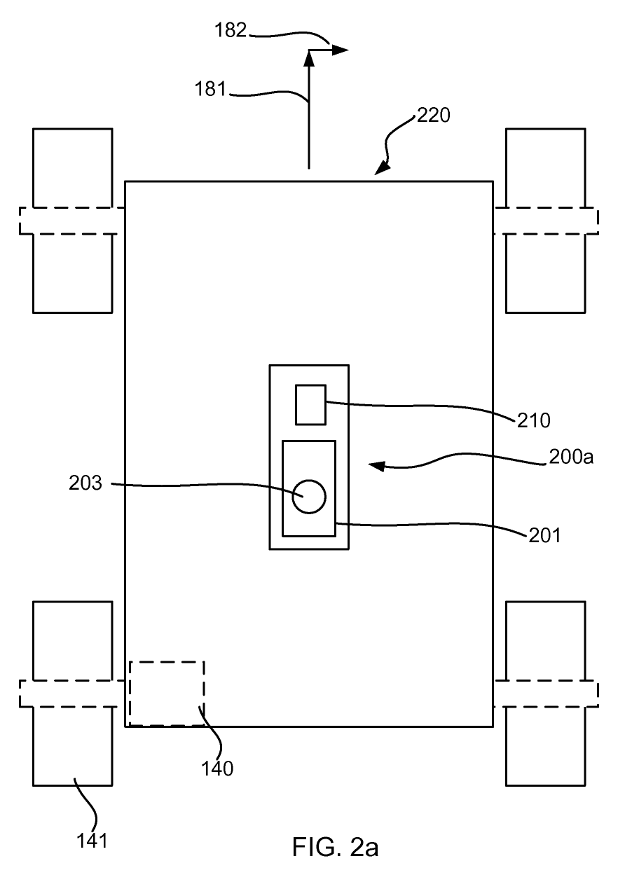

FIG. 2a illustrates a displacement sensing device (DSD) 200a in accordance with a second embodiment of the invention mounted to a propagation surface 199 of a mobile robot platform 220 in such an orientation that it faces a propagation surface of the mobile robot platform 220. The DSD 200a comprises a first optical mouse scanning assembly 201 and a processor 210 coupled therewith for receiving of data therefrom. In use, a first set of data is provided from the first optical mouse scanning assembly 201 in the form of first and second relative displacement data. In the case of FIG. 2a, the mobile robot platform 220 is shown from a bottom view where the DSD 200a is visible in a clearer manner. A motor 140, which in this case is coupled to at least a wheel 141, is provided for facilitating propagation of the mobile robot platform 220.

From this first set of data, a relative displacement determination movement determination is made in travel of the DSD 200a from the first position to the second position. Through the use of the lens 203, an image that is further away from the optical mouse scanning assembly 201 is utilized as if the optical mouse scanning assembly was operating on a propagation surface that is approximately 5 mm away from an aperture of the camera formed as part thereof. The lens 203, for example, brings the floor of a room into focus of the camera and as such allows for using objects that are a few centimeters away to be used for relative displacement determination for the robot platform as it propagates along the propagation surface. From a side view, the mobile robot platform 220 is similar to that shown in FIG. 1a.

In use, the DSD 200a is disposed in such a manner that it preferably faces the propagation surface, such as FIG. 1a, when the mobile robot platform is utilized on a propagation surface, such as propagation surface 199 (FIG. 1a). In this manner, the DSD 200a is for reading of image data from the propagation surface 199 when the body 221 is mobile relative to the floor. As such, the DSD 200a provides information for use in determining a relative distance determination for propagation along a first axis 181 for the mobile robot platform 220.

Furthermore, the DSD 200a provides information for use in determining a relative displacement from the first position to the second position a second axis 182, which is at an angle to the first axis, for the mobile robot platform. As the robot platform propagates approximately along a direction defined by the first axis 181, the rate of propagation along this axis is determined, as well, a deviation of the mobile robot platform during propagation along the first axis is also determined since the DSD 200a provides both rate and relative displacement information for two axes.

Through knowing the relative deviation from the propagation of the robot platform along the first axis, optionally corrections are made within the control circuit 210 for the robot platform such that the robot platform propagates approximately parallel to the direction defined by the first axis. Further optionally, the relative displacement information for the robot platform is used in determining relatively how far the robot platform has moved in relation to the propagation surface. So, for example, in turning, the DSD 200a is utilized in determining an approximate turning distance for the mobile robot platform. Optionally, because the OSD provides dual axis information, an approximate turning of the mobile robot platform is determinable.

Further optionally, the DSD 200a is mounted such that the optical mouse scanning assembly is facing an object or propagation surface that is other than the propagation surface, for example a wall. From the image data received from the object or wall, relative movement and displacement information is also derivable.

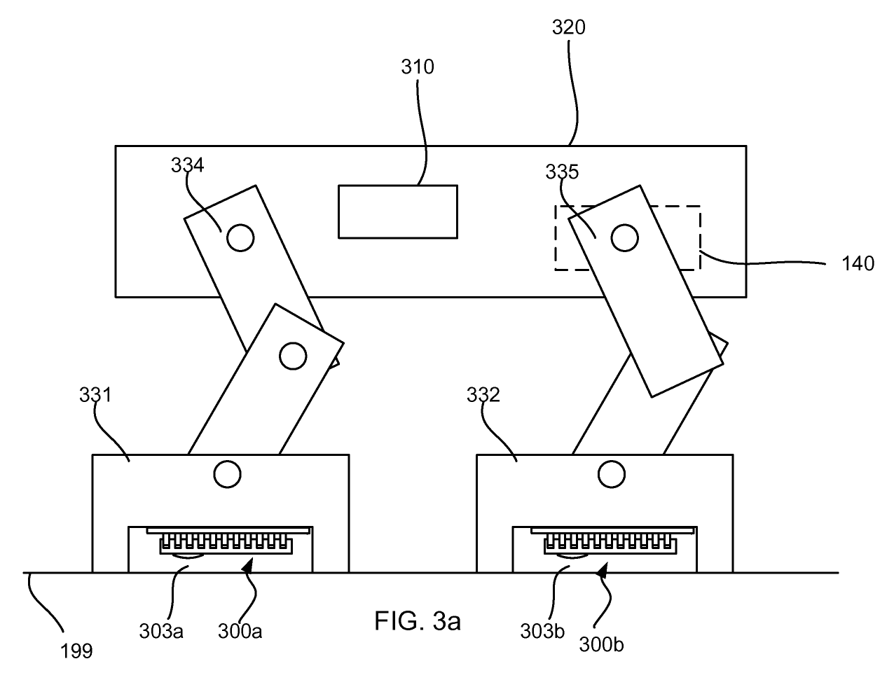

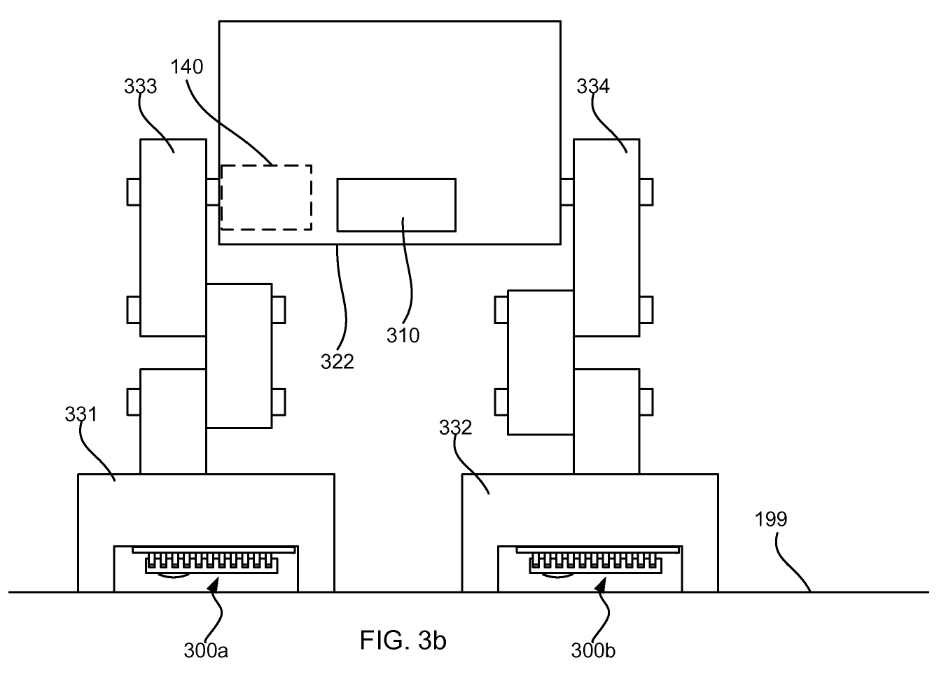

FIG. 3a illustrates a slippage sensing device (SSD) 300a in accordance with a third embodiment of the invention. The SSD 300a comprises a first optical mouse scanning assembly 301 and a processor 310 coupled therewith for receiving of data therefrom. The SSD 300a is disposed on the mobile robot platform 320 such that the first optical mouse scanning assembly 301 is disposed in at least a foot 331 of the mobile robot platform 320, and preferably two feet, wherein the second foot is denoted by 332, when the mobile robot platform is in the form of a legged mobile robot platform, or two limb mobile robot platform, comprising first and second feet, 333 and 334. As the mobile robot platform walks along the propagation surface 199, in use, a first set of data is provided from the first optical mouse scanning assembly 300a in the form of first and second relative position data. From this first set of data, a relative displacement determination is made in travel of the SSD 300a from the first position to the second position as the foot slips during walking operation of the legged robot platform. At least a motor 140 is provided for facilitating motion of the mobile robot platform 320 along the propagation surface.

The lens 303a, for example, brings the floor of a room into focus of the camera and as such allows for using the floor for relative displacement determination for the robot platform as it propagates along the propagation surface. If there is no slippage observed, as the foot is in contact with the propagation surface, the first and second position data received from the SSD 300a is such that there is very little relative displacement of the SSD 300a in relation to the propagation surface. If there is slippage observed, then the SSD 300a in the first and second sets of data provides information as to the rate of the slippage along with a relative distance of the slippage for at least one axis. Furthermore, the SSD 300a facilitates determining whether the mobile robot platform is propagating in an approximately straight direction in dependence upon whether relative displacement signals from the first and second SSDs are approximately the same. Optionally, a second SSD 300b is disposed on another foot to determine slippage for two feet and further optionally relative displacement information between the SSDs 300a and 300b are used for determining whether the legged mobile robot platform is propagating along a straight line.

FIG. 3b illustrates a two legged mobile robot platform 322 from a front view, where SSDs 300a and 300b are used for determining foot slippage as well as optionally determining whether the mobile robot platform propagates along an approximately straight line. Preferably when the SSD is utilized on the foot of the legged robot, a light source is also provided for illuminating the propagation surface on which the legged. Of course, providing of the light source is also preferable when the DSD and the OSD are utilized. At least a motor 140 is provided for facilitating motion of the mobile robot platform 322 along the propagation surface.

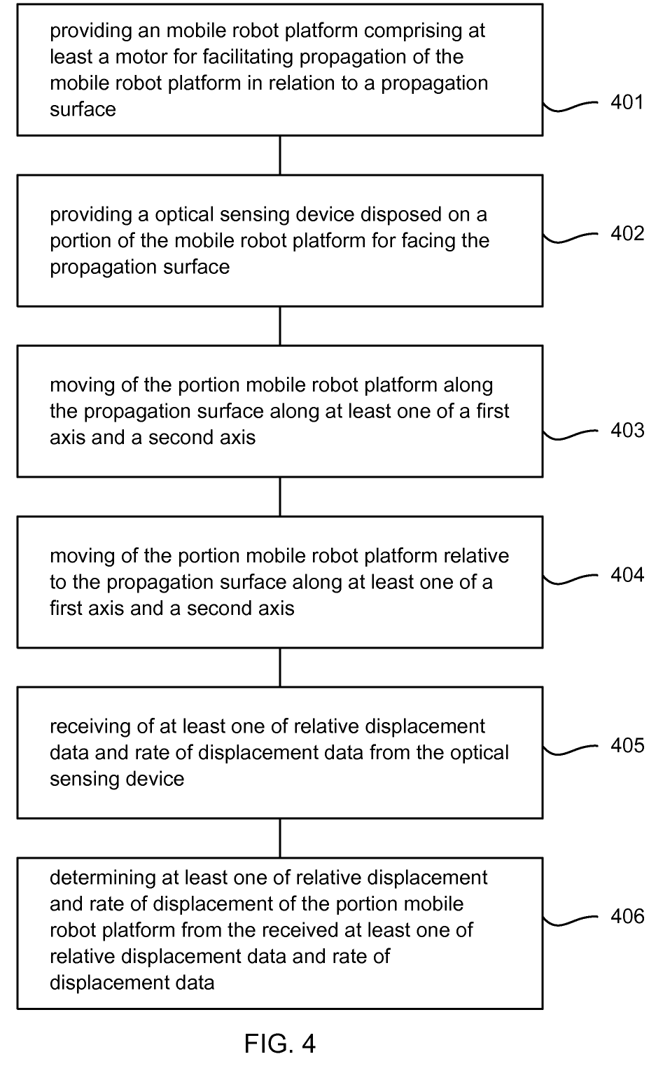

FIG. 4 illustrates a method for the mobile robot platform, such as the mobile robot platform shown in FIGS. 1a, 3a and 3b. In a first step 401, a mobile robot platform is provided that comprises at least a motor for facilitating propagation of the mobile robot platform in relation to a propagation surface. In a second step 402 an optical sensing device is disposed on a portion of the mobile robot platform for facing the propagation surface. In a third step 403 the portion mobile robot platform is moved along the propagation surface along at least one of a first axis and a second axis. In a fourth step 404, at least one of relative displacement data and rate of displacement data is received from the optical sensing device. In a fifth step 405, at least one of relative displacement and rate of displacement of the portion mobile robot platform are determined from the received at least one of relative displacement data and rate of displacement data.

Advantageously, by using the optical sensing device in mobile robotic applications, various parameters, such as propagation velocity, slippage and relative displacement are determinable for the mobile robot in relation to a propagation surface. Optionally, a light source is provided such that it illuminates a field of view of the optical mouse scanning assembly to facilitate use in environments where sufficient illumination is not provided to the optical sensing device for envisaged usage in accordance with the embodiments of the invention.

Numerous other embodiments may be envisaged without departing from the spirit or scope of the invention.

What is claimed is:

1. A mobile robot platform comprising:
a least a motor for facilitating propagation of the mobile robot platform in relation to a propagation surface;
a control circuit comprising a memory circuit;
a body comprising a portion of the body disposed at a first distance from the propagation surface; and,
an optical sensing device (OSD) disposed on the portion of the body facing the propagation surface,
wherein the OSD is for reading of image information from the propagation surface and for generating image data in dependence thereon.

2. A mobile robot platform according to claims 1 wherein from the image data the OSD provides information for use in determining at least one of a relative displacement and a movement speed of the mobile robot platform in at least one of a first axis and a second axis when the body of the mobile robot platform is moved relative to the propagation surface.

3. A mobile robot platform according to claims 2 wherein from second axis is at an angle in relation to the first axis.

4. A mobile robot platform according to claims 1 wherein from the image data the OSD provides information for use in determining a deviation in position of the mobile robot platform from the first axis during propagation of the mobile robot platform approximately along the first axis, where this deviation is represented by displacement along the second axis.

5. A mobile robot platform comprising:
a least a motor for facilitating propagation of the mobile robot platform in relation to a propagation surface;
a control circuit comprising a memory circuit;
a body comprising a portion of the body disposed at a first distance from the propagation surface;
a first wheel and a second wheel coupled to the at least a motor and disposed along an approximately common axes and at opposite sides of the body for rotating relative to the body and for contacting the propagation surface; and,
a first optical sensing device (OSD) disposed on a portion of the body facing the propagation surface for providing of relative displacement and rate information in relation to movement of the OSD in relation to the propagation surface,
wherein the first OSD is for generating at least one of velocity and relative displacement information for the body of the mobile robot platform.

6. A mobile robot platform according to claim 7 wherein the memory circuit comprises data for executing a balance control loop and the mobile robot platform comprises: an accelerometer coupled with the control circuit, the control circuit for coupling to the OSD for using the relative displacement and rate information from the OSD and the accelerometer for executing the balance control loop for facilitating approximate balancing the mobile robot platform on two wheels where the mobile robot platform does not approximately deviate from a current position when the body of the mobile robot platform is mobile relative to the propagation surface.

7. A mobile robot platform according to claim 6 comprising: a second OSD facing the propagation surface and coupled with the control circuit, the control circuit for receiving relative displacement and rate information from the first and second OSDs and the accelerometer for executing a balance control loop for facilitating approximate balancing of the mobile robot platform on two wheels, wherein the balance control loop comprises instruction data for performing at least one of a difference and a sum operation on the relative displacement and rate information from the first and second OSDs for determining a rate of tilt of the mobile robot platform during one of forward and backward movement thereof.

8. A mobile robot platform according to claim 7 wherein at least one of the first OSD and the second OSD is for determining a relative displacement of the mobile robot platform in at least one of a first axis and a second axis when the body of the mobile robot platform is mobile relative to the propagation surface.

9. A mobile robot platform comprising:
a least a motor for facilitating propagation of the mobile robot platform in relation to a propagation surface;
a control circuit comprising a memory circuit;
a body comprising a portion of the body disposed at a first distance from the propagation surface; and,
a first leg coupled with the at least a motor and comprising a first foot and a second leg comprising a second foot, the first and second leg disposed along an approximately common axes and at opposite sides of the body for moving relative to the body and for contacting the propagation surface;
a first optical sensing device (OSD) disposed on the first foot for facing the propagation surface for providing of at least one of relative displacement and displacement rate information in relation to movement of the first foot in relation to the propagation surface.

10. A mobile robot platform according to claim 9 wherein the relative displacement and displacement rate information for the first OSD is used for determining a slippage of the foot in relation to the propagation surface when the first foot is in approximate contact with the propagation surface.

11. A mobile robot platform according to claim 9 comprising a second optical sensing device (OSD) disposed on the second foot for facing the propagation surface for providing of relative displacement and displacement rate information in relation to movement of the second foot in relation to the propagation surface.

12. A mobile robot platform according to claim 10 wherein the relative displacement and displacement rate information for the second OSD is used for determining a slippage of the foot in relation to the propagation surface when the second foot is in approximate contact with the propagation surface.

13. A mobile robot platform according to claim 11 wherein at least one of the relative displacement and displacement rate information for at least one of the first OSD and the second OSD are used for determining a deviation of the mobile robot platform along a second axis when the mobile robot platform is propagating along a first axis, wherein the second axis is other than the first axis.

14. A method comprising: providing an mobile robot platform comprising at least a motor for facilitating propagation of the mobile robot platform in relation to a propagation surface;
providing a optical sensing device disposed on a portion of the mobile robot platform for facing the propagation surface;
moving of the portion mobile robot platform along the propagation surface along at least one of a first axis and a second axis;
receiving of at least one of relative displacement data and rate of displacement data from the optical sensing device; and,
determining at least one of relative displacement and rate of displacement of the portion mobile robot platform from the received at least one of relative displacement data and rate of displacement data.

15. A method according to claim 14 comprising:
providing a limb coupled with the at least motor;
providing a foot coupled with the limb, wherein the limb comprises the portion of mobile robot platform;
contacting the propagation surface with the foot; and,
determining a slippage of the foot in dependence upon at least one of the relative displacement data and the rate of displacement data.

16. A method according to claim 15 comprising:
varying the moving of the portion mobile robot platform relative to the propagation surface along at least one of a first axis and a second axis in dependence upon the determination of the slippage of the foot.
